(19) United States
(12) Patent Application Publication
(10) Pub. No.: US 2005/0097006 A1
(43) Pub. Date: May 5, 2005

(54) Method and apparatus for digital media distribution

(76) Inventor: George Nyako, Santa Clara, CA (US)

Correspondence Address: George Nyako, 805 Transill Circle, Santa Clara, CA, 95054, US

(21) Appl. No.: 10/978,169

(22) Filed: Oct. 30, 2004

Related U.S. Application Data
(60) Provisional application No. 60/516,421, filed on Nov. 3, 2003.

(51) Int. Cl. G06F 17/60

(52) U.S. Cl. 705/26; 705/1

(57) ABSTRACT

Methods and systems for distributing digital media. In one implementation, the system includes a distributor to store digital media on a digital medium at a first site, the digital media having been previously generated by a content generator; a first end user to purchase the digital media from the distributor, and download the digital media from the first site onto a digital medium at a second site; and a second end user to purchase the digital media from the first end user, and download the digital media from the second site onto a digital medium at a third site, wherein the distributor provides a credit to the first end user for the purchase of the digital media by the second end user. In general an arbitrary mth end user to purchase the digital media from another arbitrary nth end user, and obtain the digital media by any means from the nth end user's site or any site affiliated with the nth end user, and wherein the distributor provides a credit to the nth end user or any affiliated end users for the purchase of the digital media by the mth end user.

### CROSS-REFERENCE TO RELATED APPLICATIONS

The present application claims priority to U.S. Provisional Patent Application No. 60/516,421, filed on Nov. 3, 2003, which is incorporated herein by reference in its entirety.

### BACKGROUND

This disclosure relates to digital media and digital media distribution.

The interests of music labels and free music downloaders (or consumers) can at times be in conflict. For example, some consumers see no reason to buy music when they can download the music for free over the Internet. In general, music labels need revenues from music sales to survive, and the music labels are struggling to solve the problem of illegal music download.

Recently the Recording Industry Association of America (RIAA) has started suing consumers who illegally download music, but with over an estimated 60 million people regularly downloading music illegally, suing consumers is not viable or sustainable solution. With digital music downloads expected to soar, the music industry needs to find a solution to illegal downloads that will bring compromise to the seemingly mutually exclusive interests of the parties involved.

In general, this specification describes a method for distributing digital content over networks in a way that reduces the incentive for illegal distribution by rewarding users for being legal distributors.

In general, in one aspect, this specification describes a system for sharing digital content among peers in a peer-to-peer network.

Particular implementations can include a downloadable computer software program, known as a client, which permits users (e.g., consumers) to communicate and share digital content with each other. In one implementation, the client can function as an instant messenger client for users to communicate with each other via text, audio and/or video messages. The client can also provide a discovery mechanism for finding other users on a network. The client can also provide a search mechanism for finding digital content on a network. In one implementation, the client provides a mechanism for sharing digital content on a network, and sending and receiving such content to and from other users respectively.

Another implementation of the above mentioned client is an internet website interface that provides all the functionality of the above mentioned-downloadable client. The internet website interface can be used with any web-browser (e.g. Internet Explore, Mozilla FireFox, Netscape Navigator), or with any computer software that can host web pages (e.g. Windows Media Player, MSN Messenger client, and the like).

Another implementation of the above mentioned client is in the form of a computer software plug-in or add-on, that extends the functionality of any computer software program to include the functionality of the above mentioned client.

In general, in another aspect, this specification describes a system for digital content owners to manage content sharing transactions among peer-to-peer users and provide above mentioned rewards to them. The system provides content owners with a precise means of targeting their marketing budget.

Particular implementations can include a network server with databases for monitoring clients, users, and accounts related to this system. The network server can provision and authenticate clients and authorize clients to conduct peer-to-peer transactions. This gives the digital content owner the means to manage incentive schemes creatively, and customize different incentives schemes to target different market segments.

In general, in another aspect, this specification describes a system for digital content owners to manage their digital content and distribute such content to subscribed peer-to-peer users.

Particular implementations can include a network server that stores original digital content and distributes the digital content to above mentioned clients and users.

Particular implementations can include a network server that uses established digital rights management schemes to digitally protect stored content. Such digital rights management schemes can ensure that only authorized clients and users will be able to utilize digital content.

Particular implementations can include a network server that manages digital rights certificates of clients such that only authorized clients and users are able to utilize digital content.

Particular implementations can include a network server that authorizes transfer of digital content from one peer client to another peer client. Such transfer can be a direct transfer, for example, from one peer to another peer. A transfer can also be an indirect transfer that goes through the network server.

In general, in another aspect, this specification describes a system for recruiting new users into above mentioned network system by providing additional rewards.

Particular implementations can include a mechanism for existing users to recruit their friends to join the above mentioned system. This can be implemented as an easy way to send emails or text messages to friends inviting them to join the network.

Other implementations can include a system that makes it easy for users to subscribe using only an email address as a unique identifier. Credits or revenue accrued can be redeemed at anytime by providing credit card, debit card or bank account information for deposit.

In general, the above mentioned systems provide rewards or commissions to peers for distributing digital content legally using above mentioned system.

Implementations can include one or more of the following advantages. In one implementation, a digital media distribution scheme is provide that is a good compromise between consumers' desires to obtain free media and content owners' desire to earn revenue from peer-to-peer distribution.

A media distribution system is provided that solves the apparent conflict of interest between consumers of digital content and content owners, and creates a legal distribution ecosystem for digital media. The media distribution system permits content owners to encourage competition among consumers of digital media and permits first consumers of digital media to offer additional credits to other consumers when the other consumers download digital media from the first consumers.

The details of one or more implementations are set forth in the accompanying drawings and the description below. Other features and advantages will be apparent from the description and drawings, and from the claims.

### DESCRIPTION OF DRAWINGS

FIG. 1 is a block diagram of a digital media distribution system.

FIG. 2A is a block diagram of a media distribution server.

FIG. 2B is a block diagram of a media client.

FIG. 3 is a method for distributing digital media.

Like reference symbols in the various drawings indicate like elements.

### DETAILED DESCRIPTION

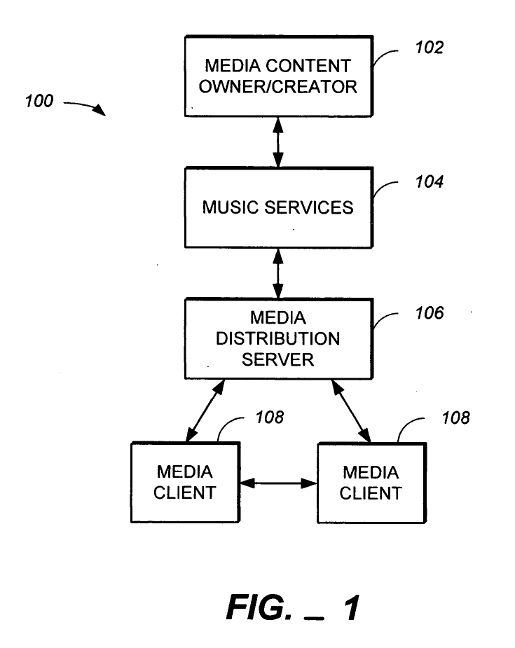

FIG. 1 is a block diagram of a digital media distribution system 100. Digital media distribution system 100 includes a media content owner 102, music services 104, a media distribution server 106 and media clients 108. Though two media clients 108 are illustrated in FIG. 1 by way of example, digital media distribution system 100 can contain a different number of media clients. Digital media distribution system 100 can be implemented using any digital rights management technology that permits transfer of digital media and digital media rights.

Digital media distribution system 100 permits digital media retailers to distribute digital media to subscribers (or downloaders) so that the subscribers can distribute or share the digital media with other subscribes without significant revenue loss to the retailer. Examples of digital media include digital music, computer software programs, electronic books, digital video, digital pictures, and so on. Digital media distribution system 100 reduces the incentive for subscribers to freely or illegally distribute digital media by permitting the subscribers to receive credits (e.g., incentives, commissions, discounts, and so on) for sharing digital media content through digital media distribution system 100. Digital media distribution system 100 also increases the incentive for subscribers to download digital media from other subscribers by giving the subscribers (who download from other subscribers) credits for doing so. With the digital media distribution scheme of digital media distribution system 100, there is potential for subscribers to earn enough credits to download media free from a retailer and even make a profit in the process.

Media content owner 102 includes entities that have an interest in the creation and distribution of digital media. For example, media content owner includes entities such as music labels (e.g., Universal Music Group, Sony Music, Virgin Records, Columbia Records, Capitol Records, Atlantic Records, Geffen Records, EMI Chrysalis, and so on), movie producers and software developers. In general, media content owner 102 provides digital media to music services 104 for distribution to consumers.

Music services 104 include services that are operable to provide digital media to consumers. In particular, music services 104 provide digital media to consumers through media distribution server 106, as discussed in greater detail below. Examples of music services include online services (e.g., Apple iTunes, Music Match, Napster, and so on) and traditional brick-and-mortar services (e.g., Tower Records, Barnes and Noble, and so on). In one implementation, music services 104 encode digital media with digital rights management using proprietary encoding.

Media distribution server 106 and media clients 108 each include one or more engines (discussed below) operable to manage digital media distribution in digital media distribution system 100. More specifically, media distribution server 106 and media clients 108 manage digital media distribution by managing client (consumer) profiles, digital rights management and sales or other transactions.

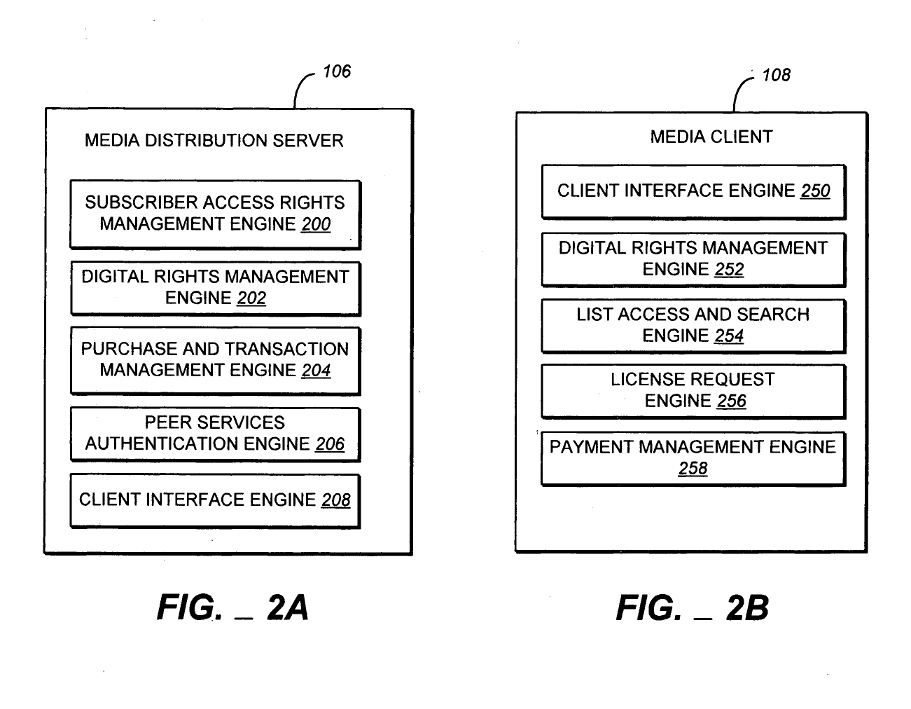

FIG. 2A shows media distribution server 106 in greater detail. Media distribution server 106 includes a subscriber access rights engine 200, a digital rights management engine 202, a purchase and transaction management engine 204, a peer services authentication engine 206 and a client interface engine 208.

Subscriber access rights engine 200 manages consumer (referred to herein as a subscriber) profiles. In one implementation, subscriber access rights engine 200 assigns a unique identifier (UI) to each subscriber. Subscriber access rights engine 200 can also assign a subscriber key to each subscriber. The subscriber keys can be used to identify downloaders that purchase digital media from a particular music service (e.g., music service 104). Subscriber access rights engine 200 can verify set up of new subscriber groups with corresponding commissions and credits systems that have been uploaded from the Certified Original Distributors (CODs).

Digital rights management engine 202 ensures that digital rights management records are consistent. Digital rights management engine 202 ensures that digital content can only be utilized by authorized subscribers on authorized systems. In one implementation digital rights management engine 202 distributes digital rights certificates to authenticated media clients 108, and these certificates enable utilization of digital content by subscribers. In another implementation, digital rights management engine 202 ensures that proprietary digital rights management of a given musical service does not conflict with proprietary digital rights of other musical services.

Purchase and transaction management engine 204 maintains aggregate records of purchases and credits accrued by each subscriber. In one implementation, purchase and transaction management engine 204 verifies account information of a subscriber and verifies credits associated with a given subscriber. Purchase and transaction management engine 204 can also keep track of content sharing transactions between media clients 108 and can implement reward schemes as appropriate.

Peer services authentication engine 206 maintains the integrity of peer-to-peer transactions between media clients 108. In one implementation, peer services authentication engine 206 ensures that media clients 108 are properly authenticated for direct peer-to-peer communication and interaction.

Client interface engine 208 provides a means for media distribution server 106 to communicate and interact with media clients 108. In one implementation, client interface engine 208 provides an interface that can be published (e.g. as web services) for interoperability with media clients 108 developed by different software companies.

FIG. 2B shows a media client 108 in greater detail. Media client 108 includes a client interface engine 250, a digital rights management engine 252, a list access and search engine 254, a license request engine 256 and a payment management engine 258.

Client interface engine 250 provides a means for media clients 108 to communicate and interact with other media clients 108 and with media distribution servers 106. Client interface engine 250 permits media clients 108 to initiate transactions. In one implementation, client interface engine 208 initiates purchase requests for content (or digital media). Client interface engine 250 can also accept or decline purchase requests for content from other peer client interface engines. And client interface engine 250 can be set to automatically accept purchase requests on some or all peers. In another implementation, client interface engine 250 can also publish transaction discounts provided by a subscriber to other subscribers.

Digital rights management engine 252 ensures that digital content can only be utilized by authorized subscribers on authorized systems. Digital rights management engine 252 ensures that digital rights management records are consistent. In one implementation, digital rights management engine 252 receives digital rights certificates from digital rights management engine 202 and unlocks digital content (or digital media) purchased by subscriber as appropriate. This ensures that digital content can only be utilized by authorized subscribers on authorized systems.

List access and search engine 254 provides a means for subscribers to discover digital content. In one implementation, list access and search engine 254 is used to discover content residing on media distribution servers 106 and other media clients 108. List access and search engine 254 can also be used to browse and display meta-data associated with discoverable digital content. List access and search engine 254 can also maintain a list of local discoverable digital content that can be searchable by other media clients 108. Such list can be published on media distribution servers or requested via the client interface engine 250 or broadcast to other media clients 108.

License request engine 256 retrieves and manages licenses that are necessary to utilize digital content and operate media client. For example, digital rights management licenses which have to be obtained from multiple sources for different content types will be obtained by the license request engine. In one implementation, license request engine 256 renews licenses as appropriate.

Payment management engine 258 interacts with purchase and transaction management engine 204 to initiate purchases and maintain records of purchases and credits accrued by each subscriber. In one implementation, payment management engine 258 requests authorization from purchase and transaction management engine 204 for media clients that want to execute a purchase transaction. Payment management engine 258 also provides an interface for subscribers to manage their account information related to purchasing. For example, subscribers can keep track of account balances, credits, etc.

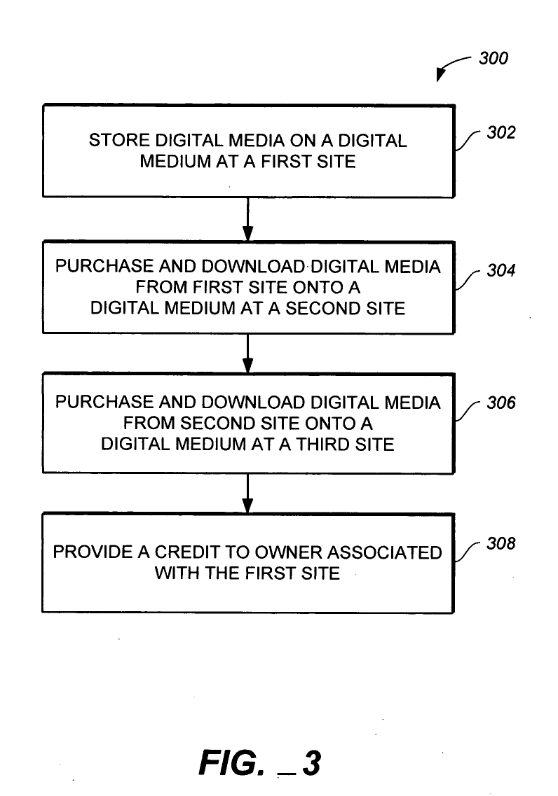

FIG. 3 shows a method 300 for distributing digital media. Digital media is stored on a digital medium at a first site (step 302). In one implementation, a distributor (or musical service) stores digital media onto a media distribution server (e.g., media distribution server 106). The digital media is purchased and downloaded from the first site onto a digital medium at a second site (step 304). In one implementation, a first end user (or consumer) purchases the digital media from the distributor, and downloads the digital media from the first site (e.g., the media distribution server) onto a digital medium at a second site (e.g., media client 108).

The digital media is purchased and downloaded from the second site onto a digital medium at a third site (step 306). In one implementation, a second end user purchases the digital media from the first end user, and downloads the digital media from the second site onto a digital medium at a third site (e.g., a media client associated with the second end user). A credit is provided to the first end user for the purchase of the digital media by the second end user (step 308). In one implementation, the distributor provides a commission to the first end user for the purchase of the digital content by the second end user. Credits can also be given to the first end user and the second end user, for purchases of the digital media by third end users from the second end user. For example, a third end user can purchase the digital content from the second end user, and download the digital content from the third site onto a digital medium at a fourth site. In this example, the distributor can provide a commission to the first end user and/or the second end user for the purchase of the digital content by the third end user, and so on for further purchases of the digital media.

One or more of method steps described above can be performed by one or more programmable processors executing a computer program to perform functions by operating on input data and generating output. One or more method steps can also be performed by, and apparatus can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of implementations have been described. Nevertheless, it will be understood that various modifications may be made. For example, many types of peer-to-peer communication interfaces can be used. Accordingly, other implementations are within the scope of the following claims.

1. A digital media distribution system, comprising:
a distributor to store digital media on a digital medium at a first site, the digital media having been previously generated by a content generator;
a first end user to purchase the digital media from the distributor, and download the digital media from the first site onto a digital medium at a second site; and
a second end user to purchase the digital media from the first end user, and download the digital media from the second site onto a digital medium at a third site,
wherein the distributor provides a credit to the first end user for the purchase of the digital media by the second end user.

2. The system of claim 1, further comprising a plurality of second end users to purchase the digital media from the first end user, and wherein the distributor provides a commission to the first end user for each purchase of the digital media by the plurality of second end users.

3. The system of claim 1, further comprising:
a third end user to purchase the digital media from the second end user, and download the digital media from the third site onto a digital medium at a fourth site, and wherein the distributor provides a credit to the first end user and the second end user for the purchase of the digital media by the third end user.

4. The system of claim 1, further comprising:
a third end user to purchase the digital media from the second end user, and download the digital media from the third site onto a digital medium at a fourth site, and wherein the distributor provides a credit to only the second end user for the purchase of the digital media by the third end user.

5. The system of claim 1, further comprising:
an arbitrary mth end user to purchase the digital media from another arbitrary nth end user, and obtain the digital media by any means from the nth end user's site or any site affiliated with the nth end user, and wherein the distributor provides a credit to the nth end user or any affiliated end users for the purchase of the digital media by the mth end user.
